(19) United States
(12) Patent Application Publication
(10) Pub. No.: US 2004/0006622 A1
(43) Pub. Date: Jan. 8, 2004

(54) Optimized process for balancing load for data mirroring

(76) Inventors: Don L. Burkes, Meridian, ID (US); David L. Kaminsky, Chapel Hill, NC (US); Soumitra Sarkar, Cary, NC (US); David M. Wolfe, Portland, OR (US)

Correspondence Address: THE LAW OFFICE OF IDO TUCHMAN, 69-60 108ST., SUITE 503, FOREST HILLS, NY, 11375, US

(21) Appl. No.: 10/189,270

(22) Filed: Jul. 3, 2002

(51) Int. Cl. G06F 15/173

(52) U.S. Cl. 709/225; 709/227

(57) ABSTRACT

A method, system, and computer program product for facilitating data transfers from a source node group to a target node group. In one embodiment of the invention, a source node selection request is sent to the source node group. The node selection request includes a data transfer session identifier. A source master node belonging to the source node group is configured to route the node selection request to a sending node using a predefined source node selection policy. A target node selection request is sent from the data sending node to the target node group. A target master node belonging to the target node group is configured to route the request to a receiving node using a predefined target node selection policy. The selection policies may include choosing the least loaded node in the data receiving node group.

### FIELD OF THE INVENTION

The present invention relates generally to data transfers between computer groups in a computer network, and more specifically to a system for selecting optimal data transfer nodes in multi-noded node groups.

### BACKGROUND

A computer network is a group of computers, printers, and other network devices linked together by a communication system. Computer networks allow devices within the network to transfer information between one another. A computer network can be a very small, such as two computers coupled together in close proximity to each other, or extremely large, such as thousands of interconnected network devices spanning the entire globe.

Some network systems utilize node groups to handle various resources in the network. A node group distributes work among its node group members so that no one computer (or “node”) becomes overwhelmed by task requests. For example, several computers may be organized as nodes in a node group to handle a site's e-mail services. Node groups help prevent bottlenecks in a network by distributing load between the node group members.

Generally, a node group includes a master node to keep track of the availability of each servant node in the node group. The master node utilizes a load balancer to systematically distribute tasks among the node group members. When a client requests a new session from the node group, the master node typically finds the least loaded servant node in the group and passes the session to that servant node. The servant node then performs the tasks required and communicates directly with the client.

Although conventional data transfer protocols are well suited for single client to multi-node server configurations, such protocols may not yield optimal performance during data transfers between other node configurations. This is because load balancing is carried out only at one side of the data transfer. For example, some computer systems use various data mirroring techniques to prevent data loss. Data mirroring involves copying a large quantity of data from a source node group to a target node group. The target node group stores a backup copy of the data in case the primary data is lost. During data mirroring, load balancing at the target node group is typically not performed. Thus, if the wrong node in the target node group is used for data transfer, sub-optimal performance can result from poor load balancing at the target node group.

### SUMMARY OF THE INVENTION

The present invention addresses the above-mentioned limitations of traditional node group data transfer arrangements by implementing a symmetric node selection policy in which node selection is performed at the source node group and the target node group. The node selection policy can be the least loaded node in the data receiving node group. Other node selection policies may also be implemented, such as a pre-assigned node or node selection based on the time the data transfer occurs.

Thus, an aspect of the present invention involves a computer program product having computer readable program codes for facilitating data transfers from a source node group to a target node group. The computer readable program codes are configured to cause the program to send an initial selection request from the target node group and to select a data receiving node belonging to the target node group using a predefined target node selection policy. Another aspect of the invention involves computer readable program codes configured to cause the program to send from the source node group an initial selection request and to select a data sending node belonging to the source node group using a predefined source node selection policy.

Another aspect of the present invention involves a target node group initiated method for facilitating data transfers from a source node group to a target node group. The method includes a sending operation to send from the target node group an initial selection request. A selecting operation selects a data receiving node belonging to the target node group using a predefined target node selection policy.

Yet another aspect of the present invention involves a source node group initiated method for facilitating data transfers from a source node group to a target node group. The method includes sending an initial selection request from the source node group. A selecting operation is used to select a data sending node belonging to the source node group using a predefined source node selection policy.

A further aspect of the invention is a target node group initiated system for facilitating data transfers between node groups. The system includes a target node group having a data receiving node and tangible media coupled to computer readable program codes. The computer readable program codes are configured to send from the target node group an initial selection request and select the data receiving node using a predefined target node selection policy.

Another aspect of the present invention involves a source node group initiated system for facilitating data transfers between node groups. The system includes a source node group having a data sending node and tangible media coupled to computer readable program codes. The computer readable program codes are configured to send from the source node group an initial selection request and select the data sending node using a predefined source node selection policy.

A further aspect of the invention is a system for facilitating data transfers between node groups. The the system includes a first node group initiating a data transfer with a second node group and means for selecting a node in the first group for the data transfer using a predefined node selection policy.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary network environment embodying the present invention.

FIG. 2 is a flowchart showing operations performed by one embodiment of a data transfer process, as contemplated by the present invention.

FIG. 3 is a flowchart showing operations performed by another embodiment of the data transfer process, as contemplated by the present invention.

### DETAILED DESCRIPTION OF THE INVENTION

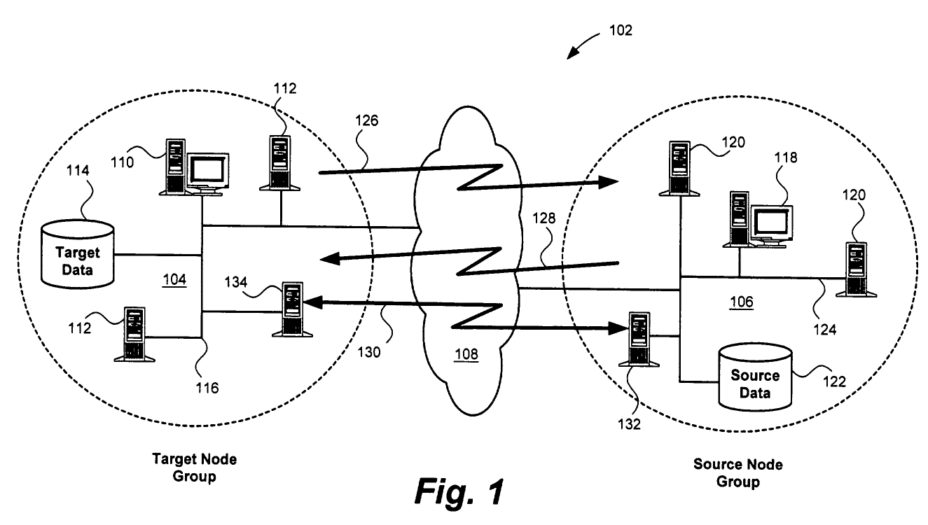

The invention is described herein with reference to FIGS. 1-3. As detailed below, the present invention beneficially facilitates large data transfers between node groups. The invention selects the best-suited nodes for large data transfers between node groups. By doing so, data transfer rates are improved and system resources are better utilized.

In FIG. 1, an exemplary computer environment 102 embodying the present invention is shown. The environment 102 includes a target node group 104 and a source node group 106 coupled to a computer network 108. The computer network 108 may be a Local Area Network (LAN), a Wide Area Network (WAN), or a combination thereof.

The target node group 104 includes a target master node 110, a plurality of target servant nodes 112, and at least one target data storage 114. Resources in the target node group 104 are coupled via a target network 116, such as a private computer network or a fiber channel. Generally, the target master node 110, also referred to herein as a target load balancer, keeps track of each servant node's availability and load, and forwards new client session requests to target servant nodes 112 with spare capacity. Thus, the target master node 110 dispatches incoming connections and packets to those target servant nodes 112 within the target node group 104 that are least loaded.

In a similar manner, the source node group 106 includes a source master node 118, a plurality of source server nodes 120, and at least one source data storage 122 coupled via a source network 124. The source master node 118 is also referred to herein as a source load balancer. In one configuration of the present invention, the target node group 104 and the source node group 106 utilize a Network Dispatcher developed by International Business Machines Corporation to achieve node load balancing. It is contemplated that the present invention may be used with other network load balancers, such as the Linux Virtual Server and various custom load balancing switches.

At some point in the computer environment 102, one of the target servant nodes 112 or the target master node 110 may require a large amount of data transferred from the source node group 106 to the target node group 104. For example, data in the source data storage 122 may be backed up and copied to the target data storage 114. In accordance with one embodiment of the present invention, and as described in detail below, the target node group 104 issues a source node selection request 126 to the source node group 106. The source node group 106 responds by selecting a sending node 132 and sending a target node selection request 128 to the target node group 104. The target node group 104, in turn, receives the target node selection request 128 and selects a data receiving node 134. A network connection 130 is created between the data sending node 132 and the data receiving node 134, and data is transferred directly the two nodes.

The present invention selects the data receiving node 134 using a predefined target node selection policy and the data sending node 132 using a predefined source node selection policy. In one embodiment of the invention, the selection policy is the least loaded node in the target node group 104. It is important to point out that the data receiving node 134 may not necessarily the original node which sent the data transfer request 126. Indeed, the data receiving node 134 may be less loaded than the original node. By choosing the least loaded data receiving node 134 to carry out the data transfer, load balance between the target nodes is maintained and data transfer rates are improved.

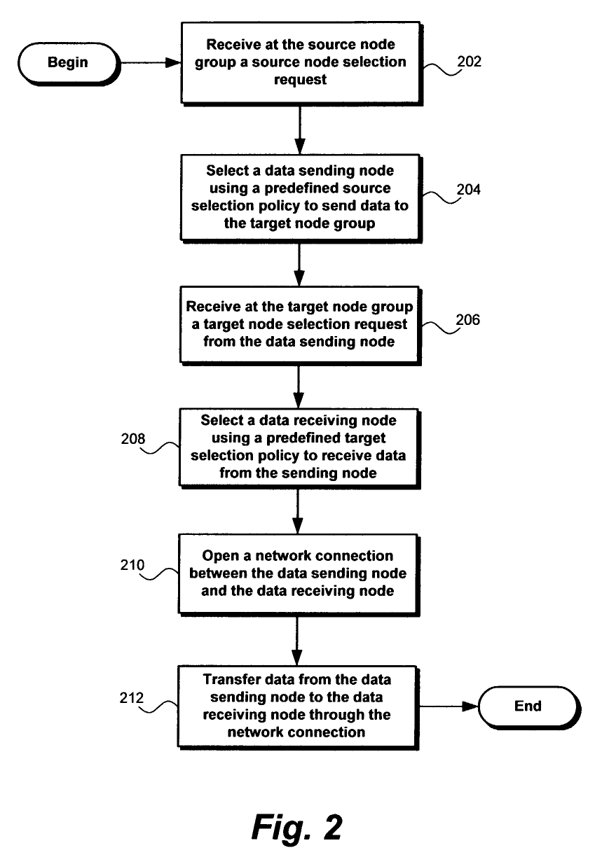

In FIG. 2, a flowchart containing operations performed by one embodiment of the present invention is shown. It should be remarked that the logical operations shown may be implemented (1) as a sequence of computer executed steps running on a computing system and/or (2) as interconnected machine modules within the computing system. The implementation is a matter of choice dependent on the performance requirements of the system implementing the invention. Accordingly, the logical operations making up the embodiments of the present invention described herein are referred to alternatively as operations, steps, or modules.

Operational flow begins with receiving operation 202. During the receiving operation 202, a requesting node in the target node group sends a source node selection request to the source node group via the computer network and the source node group receives the request. For example, requesting node may initiate a data mirroring procedure between the source node group and the target node group. The requesting node may be any node in the target node group, including the target master node. As mentioned above, the requesting node may not necessarily be the node utilized later in the procedure to receive the data from the source node group.

The source node selection request can include an indication of the type of transaction requested and a data transfer session identifier. A transaction ID may be utilized to correlate subsequent messages. After the requesting node sends the source node selection request, control flow passes to selecting operation 204.

In selecting operation 204, the master node of the source node group selects a node in the node group to act as a data sending node. In one embodiment of the invention, the data sending node is chosen using a predefined source selection policy. For example, the data sending node may be chosen by selecting the least loaded node in source node group. Other predefined source selection criteria may be used by the present invention, such as selecting a particular source node based on network partitioning or selecting a sending node based on the time the data transfer occurs. It is therefore contemplated that various node selection schemes may be employed without departing from the spirit and scope of the present invention. Once the data sending node is selected, the master node forwards the source node selection request to the data sending node and control flow passes to receiving operation 206.

In receiving operation 206, the data sending node responds to the source node selection request by sending a target node selection request to the target node group and the target node group receives the request. The target node selection request may include an indication of the type of transaction requested, the transaction ID, and the data transfer session identifier. The target node selection request may further identify which node in the source node group was chosen as the data sending node. Once the sending operation 206 is completed, control flow passes to selecting operation 208.

In selecting operation 208, the target master node selects a node member of the target node group to act as the data receiving node. The data receiving node is chosen using a predefined target selection policy. In one embodiment of the invention, the target selection policy is the least loaded node in the target node group. As mentioned above, however, other selection criteria may be used by the present invention, such as a pre-assigned node or node selection based on the time the data transfer occurs.

Once the data receiving node is selected, the target node selection request is passed to the data receiving node. The data receiving node reads the transaction ID and the type of transaction requested from the request acknowledgement. At this point, data transfer between the sending node and receiving node is ready to proceed and control transfers to opening operation 210.

In opening operation 210, a network connection between the sending node and receiving node is established. The connection protocol may be any protocol known to those skilled in the art. For example, a TCP/IP protocol may be utilized to transfer data between the sending one and the receiving node. Once a network connection is opened, control flow continues to transferring operation 212.

In transferring operation 212, the data originally requested in the source node selection request is conveyed from the sending node to the receiving node via the network connection. Note that since load balancers in both the source node group and target node group are used to select the appropriate sending and receiving nodes, optimal load balancing is achieved. Furthermore, once data transfer is initiated, traffic from the sending node to the receiving node will not be impeded by an intervening master node.

The operations performed by the present invention can be a computer readable program embodied as computer readable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the present invention can be used to select sending and receiving nodes in a target-initiated data transfer (e.g., when the target node group sends the source node selection request). It is contemplated that the present invention may also be used in a source-initiated data transfer procedure. That is, the data transfer procedure of the present invention may be initiated by one of the source servant nodes or the source master node.

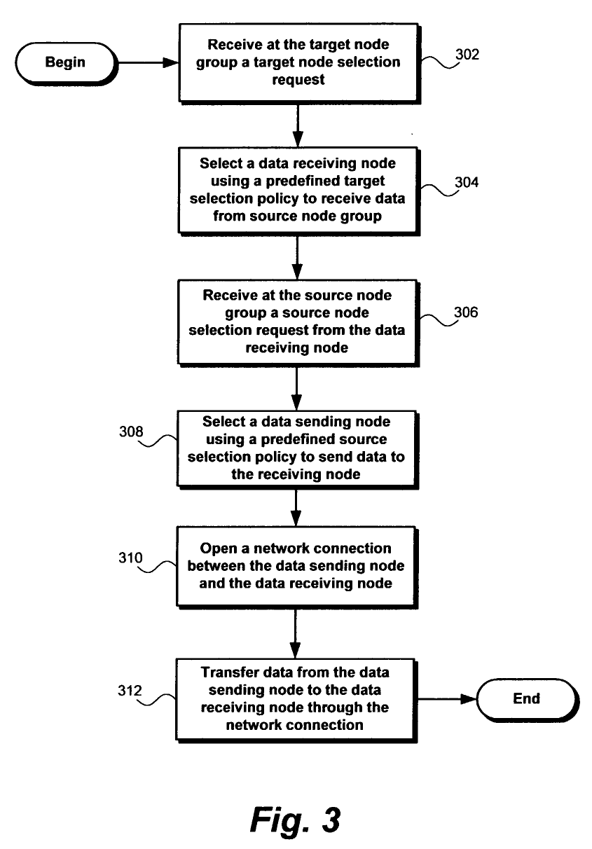

In FIG. 3, a flowchart containing operations performed by a source-initiated embodiment of the invention is shown. The source-initiated process starts by a requesting node in the source node group sending a target node selection request to the target node group at receiving operation 302. The requesting node may be any node in the source node group, including the source master node and the ultimate sending node. After the target node group receives the target node selection request, control flow passes to selecting operation 304.

At selecting operation 304, the master node of the target node group selects a node in the node group to act as a data receiving node. As discussed above, the data receiving node is selected using a predefined target selection policy, such as the least loaded node or a node based on the time the data transfer occurs. After the data receiving node is selected, the target master node passes the target node selection request to the data receiving node. Once the selecting operation 304 has completed, control flow progresses to receiving operation 306.

At receiving operation 306, the data receiving node sends a source node selection request to the source node group and the source node group receives the request. As mentioned above, the source node selection request may include an indication of the type of transaction requested, the transaction ID, and the data transfer session identifier. Once the receiving operation 306 is completed, control flow passes to selecting operation 308.

At selecting operation 308, the source master node selects a node member of the source node group to act as the data sending node. The data sending node is also chosen using a predefined target selection policy, such as the least loaded node in the target node group. Once the data sending node is selected, the source node selection request is passed to the data sending node. The data sending node reads the source node selection request and opens a network connection between the sending node and receiving node at opening operation 310. Once a network connection is opened, control flow passes to transferring operation 312.

At transferring operation 312, the data identified in the target node selection request is transferred from the sending node to the receiving node via the network connection. As discussed above, load balancers in both the source node group and target node group are used to select the appropriate sending and receiving nodes, thereby achieving optimal load balancing.

It is contemplated that other embodiments of the present invention may be configured so that the initial node selection request is received by the same node group that sent the request. Referring back to receiving operation 202 of FIG. 2, for example, the target node selection request may be issued by one of the nodes in the target node group rather than a node in the source node group. Likewise, in receiving operation 302 of FIG. 3, the source node selection request may be issued by one of the nodes in the source node group rather than a node in the target node group. In either embodiment, process flow continues as described respectively above and optimal sending and receiving nodes are selected for the data transfer.

The foregoing description of the invention has been presented for purposes of illustration and description. It is not intended to be exhaustive or to limit the invention to the precise form disclosed, and other modifications and variations may be possible in light of the above teachings. For example, alternative message sequences may be used by the present invention to select optimal sending and receiving nodes. Thus, the embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A computer program product embodied in a tangible media comprising:
computer readable program codes coupled to the tangible media for facilitating data transfers from a source node group to a target node group, the computer readable program codes configured to cause the program to:
send from the target node group an initial selection request; and
select a data receiving node using a predefined target node selection policy, wherein the data receiving node belongs to the target node group.

2. The computer program product of claim 1, wherein the initial selection request is adapted to be sent from the target node group to the source node group.

3. The computer program product of claim 2, wherein the computer readable program codes are further configured to cause the program to receive at the target node group a second selection request from the source node group, the second selection request adapted to identify a data sending node belonging to the source node group.

4. The computer program product of claim 3, wherein the computer readable program codes are further configured to cause the program to select the data sending node using a predefined source node selection policy.

5. The computer program product of claim 1, wherein the initial selection request is adapted to be sent from the target node group to the target node group.

6. The computer program product of claim 5, wherein the computer readable program codes are further configured to cause the program to send from the data receiving node a second selection request to the source node group, the second selection request adapted to identify the data receiving node.

7. The computer program product of claim 6, wherein the computer readable program codes are further configured to cause the program to select a data sending node using a predefined source node selection policy, the data sending node belonging to the source node group.

8. A computer program product embodied in a tangible media comprising:
computer readable program codes coupled to the tangible media for facilitating data transfers from a source node group to a target node group, the computer readable program codes configured to cause the program to:
send from the source node group an initial selection request; and
select a data sending node using a predefined source node selection policy, wherein the data sending node belongs to the source node group.

9. The computer program product of claim 8, wherein the initial selection request is adapted to be sent from the source node group to the target node group.

10. The computer program product of claim 9, wherein the computer readable program codes are further configured to cause the program to receive at the source node group a second selection request from the target node group, the second selection request adapted to identify a data receiving node belonging to the target node group.

11. The computer program product of claim 10, wherein the computer readable program codes are further configured to cause the program to select the data receiving node using a predefined target node selection policy.

12. The computer program product of claim 8, wherein the initial selection request is adapted to be sent from the source node group to the source node group.

13. The computer program product of claim 12, wherein the computer readable program codes are further configured to cause the program to send from the data sending node a second selection request to the target node group, the second selection request adapted to identify the data sending node.

14. The computer program product of claim 13, wherein the computer readable program codes are further configured to cause the program to select a data receiving node using a predefined target node selection policy, the data receiving node belonging to the target node group.

15. A method for facilitating data transfers from a source node group to a target node group, the method comprising:
sending from the target node group an initial selection request; and
selecting a data receiving node using a predefined target node selection policy, wherein the data receiving node belongs to the target node group.

16. The method of claim 15, wherein sending from the target node group the initial selection request includes sending the initial selection request to the source node group.

17. The method of claim 16, further comprising receiving at the target node group a second selection request from the source node group, the second selection request identifying a data sending node, wherein the data sending node belongs to the source node group.

18. The method of claim 17, further comprising selecting the data sending node using a predefined source node selection policy.

19. The method of claim 15, wherein sending from the target node group the initial selection request includes sending the initial selection request to the target node group.

20. The method of claim 19, further comprising sending from the data receiving node a second selection request to the source node group, the second selection request identifying the data receiving node.

21. The method of claim 20, further comprising selecting a data sending node using a predefined source node selection policy, the data sending node belonging to the source node group.

22. A method for facilitating data transfers from a source node group to a target node group, the method comprising:
sending from the source node group an initial selection request; and
selecting a data sending node using a predefined source node selection policy, wherein the data sending node belongs to the source node group.

23. The method of claim 22, wherein sending from the source node group the initial selection request includes sending the initial selection request to the target node group.

24. The method of claim 23, further comprising receiving at the source node group a second selection request from the target node group, the second selection request identifying a data receiving node, wherein the data receiving node belongs to the target node group.

25. The method of claim 24, further comprising selecting the data receiving node using a predefined target node selection policy.

26. The method of claim 22, wherein sending from the source node group the initial selection request includes sending the initial selection request to the source node group.

27. The method of claim 26, further comprising sending from the data sending node a second selection request to the target node group, the second selection request identifying the data sending node.

28. The method of claim 27, further comprising selecting a data receiving node using a predefined target node selection policy, the data receiving node belonging to the target node group.

29. A system for facilitating data transfers between node groups, the system comprising:
a target node group including a data receiving node; and
tangible media coupled to computer readable program codes, the computer readable program codes configured to:
send from the target node group an initial selection request; and
select the data receiving node using a predefined target node selection policy.

30. The system of claim 29, wherein the initial selection request is adapted to be sent from the target node group to a source node group.

31. The system of claim 30, wherein the computer readable program codes are further configured to receive at the target node group a second selection request from the source node group, the second selection request adapted to identify a data sending node belonging to the source node group.

32. The system of claim 31, wherein the computer readable program codes are further configured to select the data sending node using a predefined source node selection policy.

33. The system of claim 29, wherein the initial selection request is adapted to be sent from the target node group to the target node group.

34. The system of claim 33, wherein the computer readable program codes are further configured to send from the data receiving node a second selection request to a source node group, the second selection request adapted to identify the data receiving node.

35. The system of claim 34, wherein the computer readable program codes are further configured to select a data sending node using a predefined source node selection policy, the data sending node belonging to the source node group.

36. A system for facilitating data transfers between node groups, the system comprising:
a source node group including a data sending node; and
tangible media coupled to computer readable program codes, the computer readable program codes configured to:
send from the source node group an initial selection request; and
select the data sending node using a predefined source node selection policy.

37. The system of claim 36, wherein the initial selection request is adapted to be sent from the source node group to a target node group.

38. The system of claim 37, wherein the computer readable program codes are further configured to receive at the source node group a second selection request from the target node group, the second selection request adapted to identify a data receiving node belonging to the target node group.

39. The system of claim 38, wherein the computer readable program codes are further configured to select the data receiving node using a predefined target node selection policy.

40. The system of claim 36, wherein the initial selection request is adapted to be sent from the source node group to the source node group.

41. The system of claim 40, wherein the computer readable program codes are further configured to send from the data sending node a second selection request to a target node group, the second selection request adapted to identify the data sending node.

42. The system of claim 41, wherein the computer readable program codes are further configured to select a data receiving node using a predefined target node selection policy, the data receiving node belonging to the target node group.

43. A system for facilitating data transfers between node groups, the system comprising:
a first node group initiating a data transfer with a second node group; and
means for selecting a node in the first group for the data transfer using a predefined node selection policy.
